(19) United States
(12) Patent Application Publication
(10) Pub. No.: US 2021/0114757 A1
(43) Pub. Date: Apr. 22, 2021

(54) Method and Apparatus for Applying Dispensing Elements, Fixed by Means of a Gripping Device of an Applicator and Having a Flange and a Screw Cap, onto Packages

(71) Applicant: SIG Technology AG, Neuhausen am Rheinfall (CH)

(72) Inventors: Joachim Bührer, Stuehlingen (DE); Martin Rüegg, Uhwiesen (CH); Daniel Weber, Schaffhausen (CH)

(21) Appl. No.: 16/629,844

(22) PCT Filed: Jun. 26, 2018
(86) PCT No.: PCT/EP2018/025175

§ 371 Date: Jan. 9, 2020

(30) Foreign Application Priority Data
Jul. 10, 2017 (DE) 10 2017 115 335.7

(51) Int. Cl. B65B 43/50; B65B 61/18

(52) U.S. Cl. CPC B65B 43/50; B65B 3/025; B65B 61/186

(57) ABSTRACT

A method and apparatus are represented and described for applying dispensing elements, fixed by means of a gripping device of an applicator and having a flange and a screw cap, onto packages, in particular cardboard/plastic composite packages for dispensable products, wherein each dispensing element is supplied to the gripping device in an aligned position, gripped by gripper jaws of a gripper of the gripping device and is applied by said gripping device by means of its flange onto a package and pressed on there. In order, in the case of the application, to achieve individual pressing of the dispensing elements adapted to the situation even on uneven gable surfaces of the packages with a uniformly distributed force in a single pressing operation, the method according to the invention provides the following steps: gripping a dispensing element by closing the gripper jaws, lowering each gripping device with gripped dispensing element onto a package transported therebelow into an application position, pressing the flange of the dispensing element onto the package by means of a pressing head for a predetermined time, wherein the pressing head is freely movable in the spatial environment by a predefined angle range and can be adapted to the respective form of the package gable in the case of pressing and in that the middle point of the intended adhesive surface remains immovable and raising each gripping device to receive a newly-supplied dispensing element.

The invention relates to a method and an apparatus for applying dispensing elements, fixed by means of a gripping device of an applicator and having a flange and a screw cap, onto packages, in particular cardboard/plastic composite packages for dispensable products, wherein each dispensing element is supplied to the gripping device in an aligned position, gripped by gripper jaws of a gripper of the gripping device and is applied by said gripping device by means of its flange onto a package and pressed on there.

“Dispensing elements” are mentioned in the present case, thus this should not only be understood as pure dispensing elements, but rather also resealable opening elements of all types, which are nowadays mainly used at the same time as dispensing elements. For the sake of brevity however, only dispensing elements are mentioned in this application.

Cardboard/plastic composite packages are known from practice in widely different variations. The composite material comprises at least one carrier layer made of cardboard and in each case layers of polyethylene sealed on the outside which protects the cardboard from moisture. The composite material can also contain an aluminium layer for aseptic filling products in order to achieve a good barrier effect against gases and also light. The actual forming and filling of the packaging and the subsequent sealing to form a package occurs in a packaging machine which is generally also referred to as an FFS machine (form-fill-seal machine). The known packages are manufactured either from individual package sleeve blanks (so-called blanks) or filled with product from a package laminate of the roll and sealed and separated only after the manufacturing of the package.

The filled and sealed packages are often provided in a subsequent step with package aids such as for example resealable opening and dispensing elements. This occurs by means of separate applicators, to which the finished packages have to be supplied individually. The application takes places in this case normally on a predetermined weakened area on the package gable, such as for example a so-called “an overcoated hole” which is matched to the dispensing element to be applied in each case.

A method and an apparatus for applying dispensing elements onto packages with all the features of the preamble of claim 1 or claim 8 are known from the generic EP 2 376 331 A1. In this case, the dispensing elements are firstly transferred individually to a plurality of gripping devices of an applicator. The gripping devices apply, in the case of the known apparatus, the dispensing elements onto the surface sections of the packages intended therefor, which are also individually supplied to the applicator. In the case of this apparatus, different contact surfaces of the flange of the dispensing element, which has two different levels, is pressed with different pressing elements onto the package surface. The actual pressing in this case takes place in a plurality of operations in succession. After the dispensing elements are applied, the packages are removed from the applicator.

What is disadvantageous with the previously described apparatus is that the different contact surfaces of the flange of the dispensing element are pressed by means of a plurality of individual pressing operations onto the intended points of the package surface in order to achieve optimal pressing on all contact surfaces. To this end, different pressing elements are used in a plurality of operations in succession.

Even in the case of dispensing elements with a flange in only one level, the situation changes in the case of application due to the uneven and in each case different contact regions of the gable surfaces and requires individual pressing depending on the respective situation of the gable surface of each package.

Proceeding from here, the object underlying the present invention is to design and further develop the method mentioned in the introduction and a corresponding apparatus for applying dispensing elements, fixed by means of a gripping device of an applicator and having a flange and a screw cap, onto packages such that in the case of application, individual pressing of the dispensing elements adapted to the situation even on uneven gable surfaces of the packages force can be achieved with uniformly distributed in a single pressing operation.

This object is achieved in the case of a method with the features of the preamble of claim 1 by the following steps:
gripping a dispensing element by closing the gripper jaws,
lowering each gripping device with gripped dispensing element onto a package transported therebelow into an application position,
pressing the flange of the dispensing element onto the package by means of a pressing head for a predefined time, wherein the pressing head is freely movable in the spatial environment by a predefined angle range and can be adapted to the respective form of the package gable in the case of pressing and the middle point of the intended adhesive surface remains immovable and
raising each gripping device to receive a newly-supplied dispensing element.

According to the invention, a very exact and simultaneous pressing of the individual dispensing elements at the application location is achieved even in the case of differently formed and flexible contact surfaces on the gable surfaces of the individually slightly different packages in only a single pressing operation. The application according to the invention leads to a secure connection of dispensing element and package and operates essentially free of interruptions even at high machine speeds.

In a further configuration of the invention, it is provided that prior to pressing the flange of the dispensing element, a pressing head of the gripping device is unlocked. In this way, the pressing head can be optimally adapted to the respective gable surface when it is mounted on the package gable.

According to a further teaching of the invention, the pressing head of the gripping device after it is unlocked is freely movable in the spatial environment by a predefined angle range by way of a spherical mounting. In this case, the friction of the contact surfaces of the spherical mounting is preferably minimised by an air cushion.

A further preferred configuration of the invention provides that the pressing head of the gripping device is aligned to lock exactly parallel to the vertical axis of the gripping device.

This allows a controlled gripping of the dispensing elements.

In order to join the dispensing element to the package surface, the flange of each dispensing element is wetted with an adhesive after gripping by an application station to wet the flange. According to an alternative preferred configuration, it is provided that the flange is activated after gripping by the gripping device of an activation station to activate the contact region of the flange by means of heat, UV light or the like.

In the case of an apparatus with the features of the preamble of claim 8, the object is achieved in that each gripping device has at least one axially displaceable pressing head above the gripper jaws, which is arranged movably on a support block of the gripping device, in that the pressing head can be locked by means of a locking apparatus in an aligned position and, in the case of the released locking apparatus, its contact surface to press on the dispensing element can be adapted to the individual alignment of the dispensing element according to its respective position on the gable surface of the package in order to transfer the actual pressing force uniformly on the dispensing element to ensure a uniform connection to the package surface.

Through this design, it is ensured according to the invention that when the dispensing element is placed on the package by means of the gripping device, on the one hand, an optimal adaptation of dispensing element and package surface can be achieved and that, on the other hand, the pressing head can uniformly apply the pressing force in this individual position. As a result, a very uniform glue application profile and very good adhesion are achieved.

In a preferred configuration of the invention, the applicator is designed as a rotary machine, wherein the gripping devices are expediently arranged uniformly distributed over the circumference of the applicator.

Rotary machines are understood as all applicators, in the case of which the transport path of the dispensing elements to be applied and transported on the applicator are transported along a path which is largely identically to the transport path of the packages transported by the applicator. Ideally, rotary tables are also understood by this, wherein the term rotary machines, however, also expressly comprises such applicators in the case of which the transport paths of the dispensing elements and packages deviate from a round shape.

A further teaching according to the invention is characterised in that the pressing head is designed on its upper side as a spherical calotte and in that the support block has a corresponding spherical shell.

A ring channel is preferably provided in the spherical shell to uniformly introduce air to reduce the friction between spherical calotte and spherical shell. In this way, after unlocking the locking element, the pressing head can freely pivot in the spatial environment due to its spherical mounting in a certain angle range in order to adapt the different configurations of the surfaces of the gable surfaces.

A further teaching provides that the pressing head has in the upper region of the spherical calotte a circumferential shoulder which is movably mounted in a ring gap between spherical shell and a support ring arranged under the support block and in that to this end the support ring also has the shape of a spherical calotte on its upper side. This forming ensures that the pressing head is always located at the same distance from the support block located thereunder.

Alternatively, a solution by means of springs, a cardan joint or two-axis ball mechanics is also conceivable in order to leave the middle point of the intended adhesive surface immovable also in the case of spatial adaptation.

According to a further teaching of the invention, the gripper jaws are designed chamfered towards the dispensing element. In cooperation with the previously described pressure ring of the pressing head, which tapers conically downwards, the pressure, which is firstly applied on the gripper jaws, directly ensures a uniform pressing force on the flange of the dispensing element.

A further preferred design of the invention provides that the pressing head is designed fixable by means of a locking device in a centred position. Furthermore, the locking device to this end has a locking element protruding into a hollow space of the pressing head which expands conically downwards and the hollow space in the pressing head tapers corresponding upwards. In the case of an actuation of the locking element, the pressing head is always aligned by the corresponding conical surfaces in the direction of the vertical axis of the gripping device. As a result, the underside of the pressing head is always aligned parallel to the level of the gripper jaws and is wedged in this position. According to a further teaching of the invention, the locking element is displaceable by means of a plunger from its locked position into an unlocked position in order to ensure the free pivotability of the pressing head.

To this end, an inner plunger axially displaceable in a base body of the gripping device for locking or unlocking the pressing head is preferably provided as the plunger. The inner plunger is in this case preferably mounted so as to be displaceable in a hollow plunger and the hollow plunger is fixedly connected to the support block.

A further preferred configuration of the invention provides that the hollow plunger is also mounted so as to be axially displaceable in the base body and is designed to be axially displaceable relative to the inner plunger.

In order to actuate the two plungers, an actuation arm can be provided which is fixedly connected to the inner plunger. Expediently, the hollow plunger is designed so as to be axially movable for rotation lock relative to the inner plunger, wherein the movement is prevented by a pin, fixedly fastened to the inner plunger and arranged perpendicular to its longitudinal axis, and assigned elongated holes in the hollow plunger.

A further teaching according to the invention provides that the hollow plunger is pretensioned in a spring-loaded manner towards the actuation arm, wherein the pretensioning can be applied between hollow plunger and actuation arm by means of a pressure spring.

A dispensing element fixed by the gripper jaws of the gripping device is, after the underside of its flange has been wetted with an adhesive or the like, placed by the gripping device on the intended point of the gable surface of a package, in this case, a uniform glue application profile is generated in the case of first placement. Any unevenness in the package surface and/or in the case of the dispensing element is balanced out after opening the gripper jaws as a result of the pressing head now directly acting on the screw cap. After the locking element is unlocked, the pressing head can to this end prepare for the respective situation by it being freely movable through its spherical mounting within predefined limits. In this way, a reliable and still individual application of the dispensing elements on their respective place of destination is achieved.

The invention will be explained in greater detail below on the basis of a drawing merely representing a preferred exemplary embodiment. In the drawing:

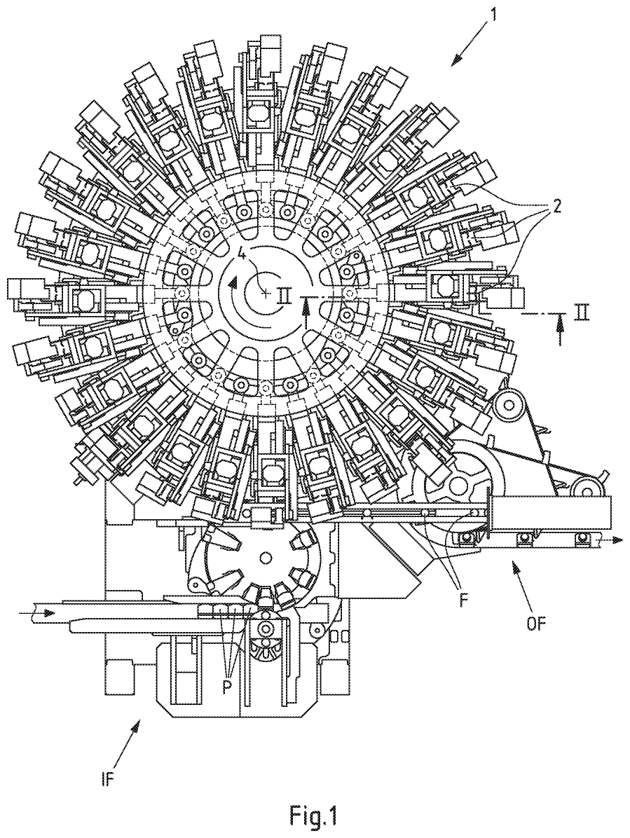

FIG. 1 shows an apparatus according to the invention in plan view,

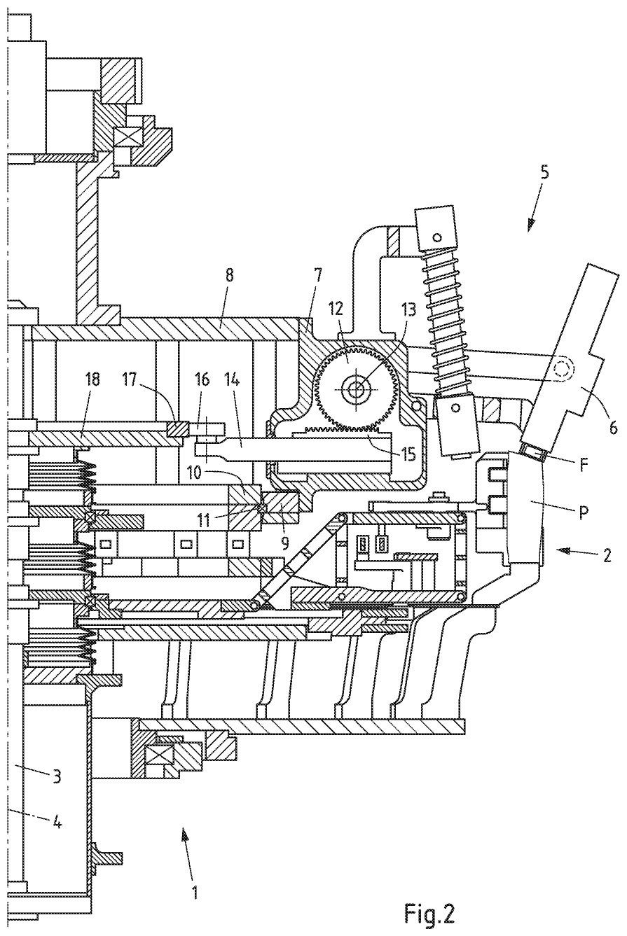

FIG. 2 shows the apparatus according to the invention from FIG. 1 in vertical section along the line II-II in FIG. 1,

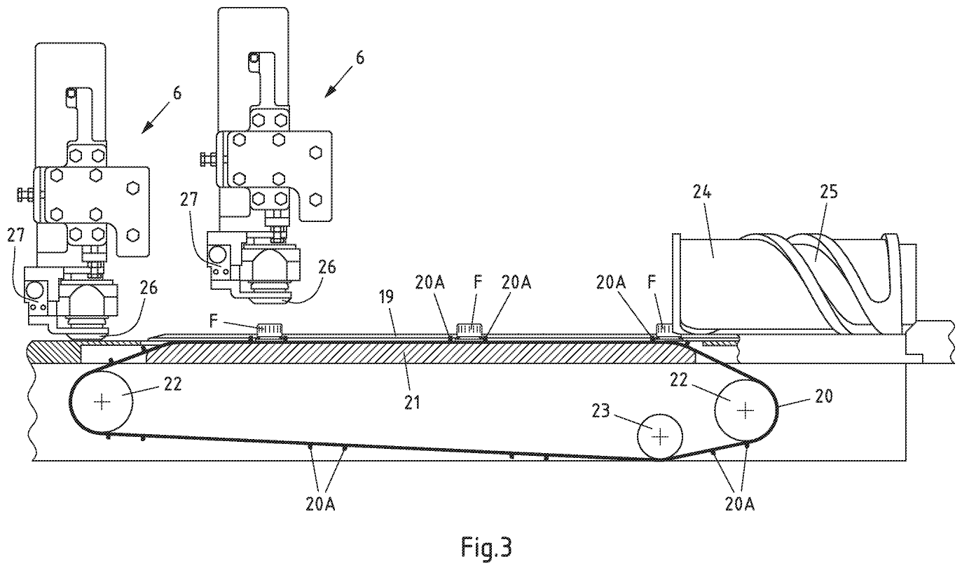

FIG. 3 shows a part of the apparatus according to the invention with a feed rail and a transport belt for dispensing elements and with two gripping devices,

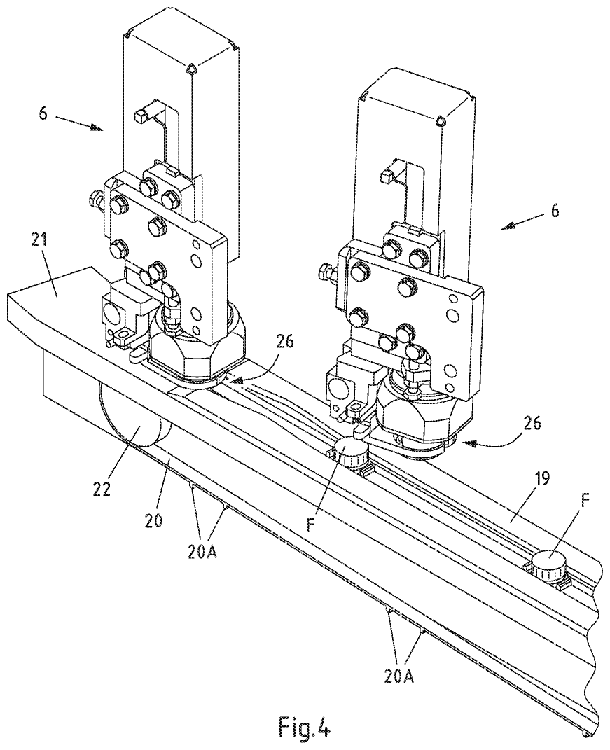

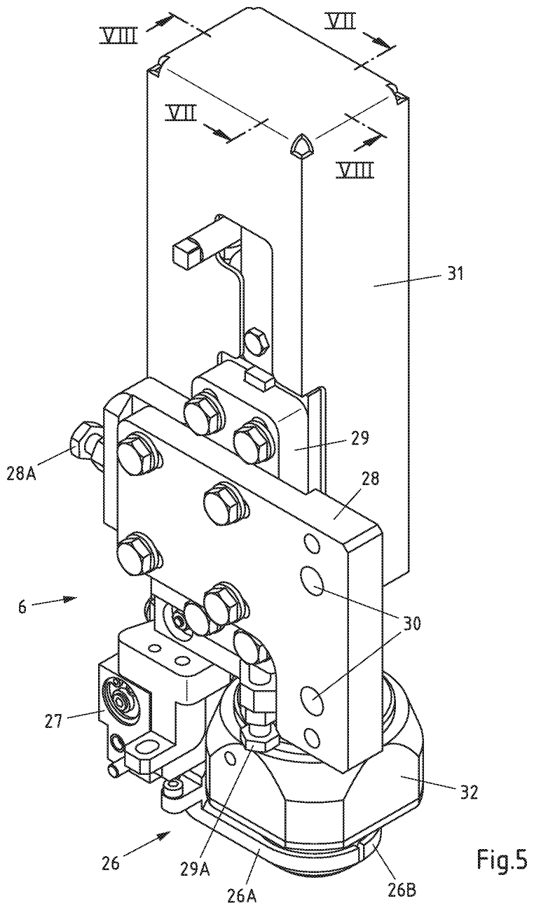

FIG. 4 shows the gripping devices and the feed rail from FIG. 3 in perspective representation,

FIG. 5 shows an individual gripping device from FIG. 3 in perspective representation,

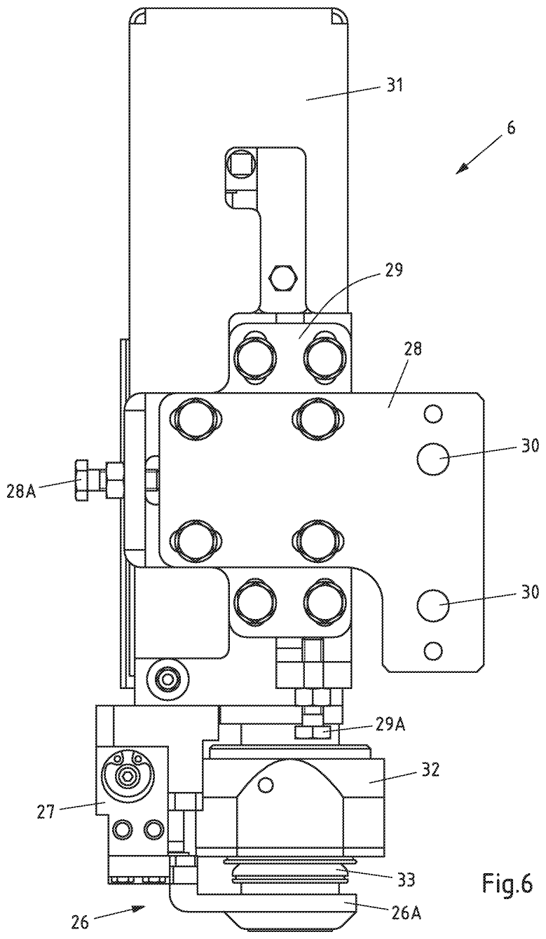

FIG. 6 shows the gripping device from FIG. 5 in side view,

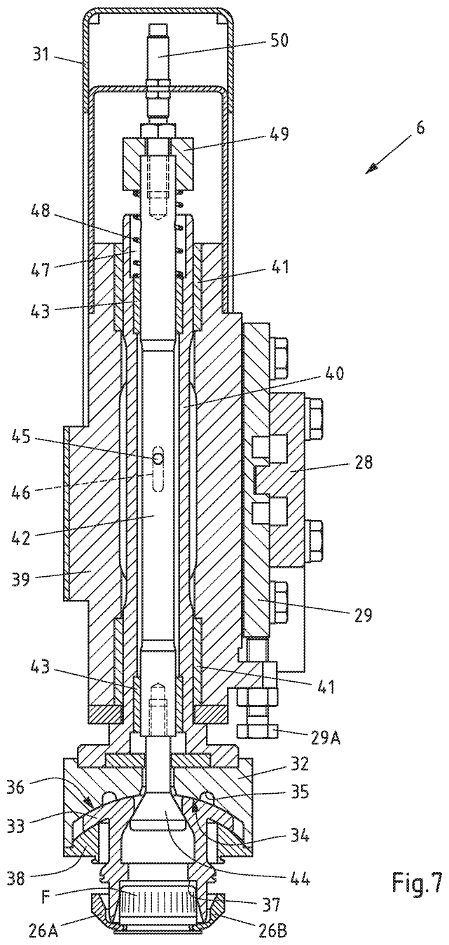

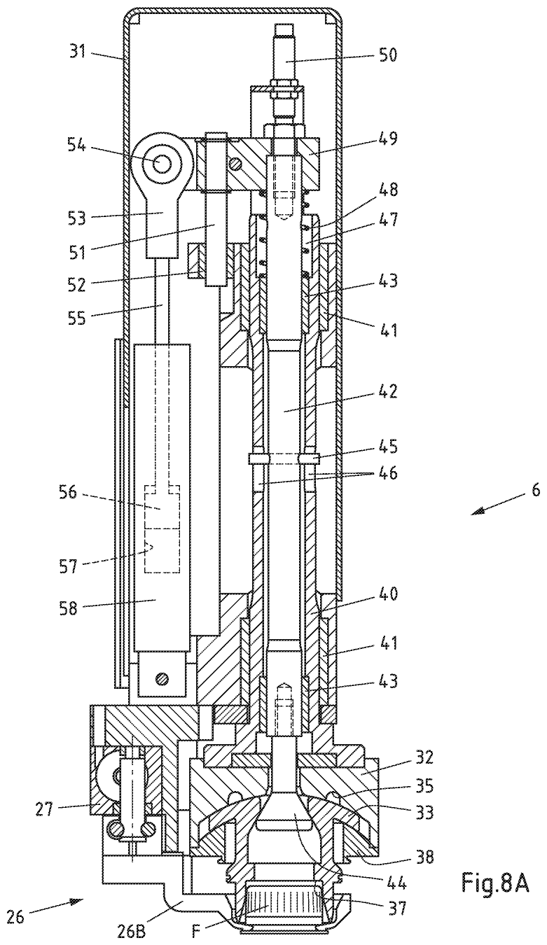

FIG. 7 shows the gripping device in vertical section along the line VII-VII in FIG. 5,

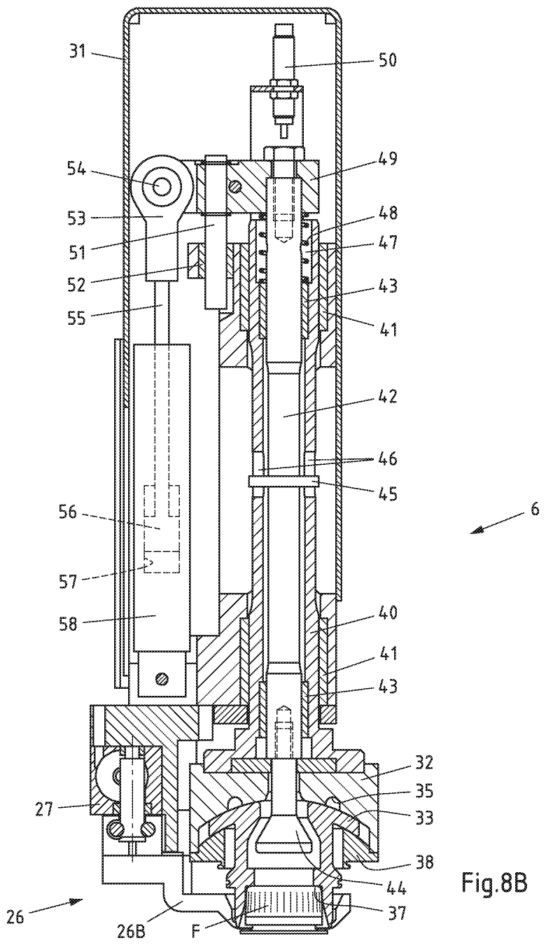

FIGS. 8A and 8B show the gripping device in vertical section along the line VIII-VIII in FIG. 5 in locked and in unlocked position,

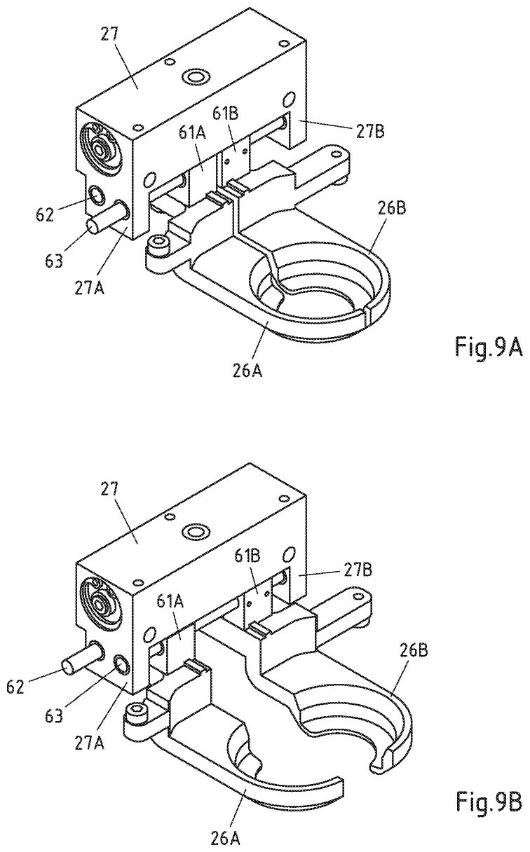

FIGS. 9A and 9B show a gripper of the gripping device from FIG. 5 in different positions in perspective representation,

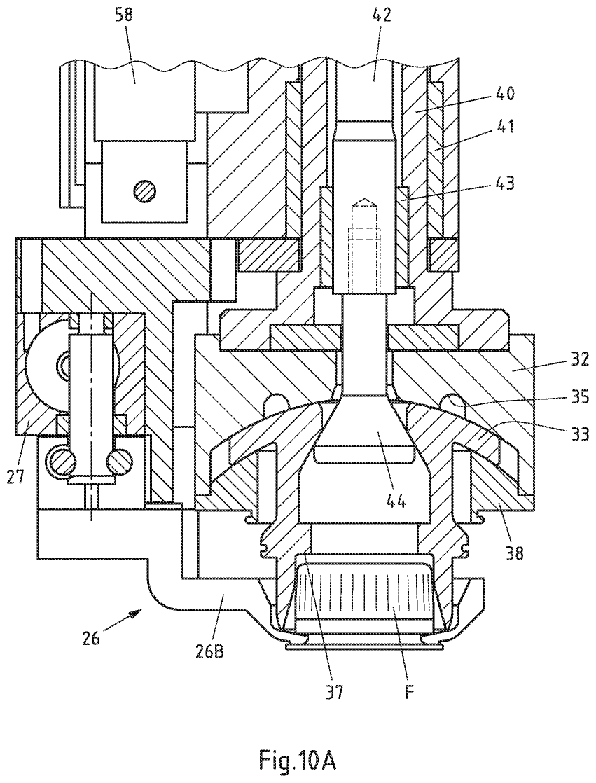

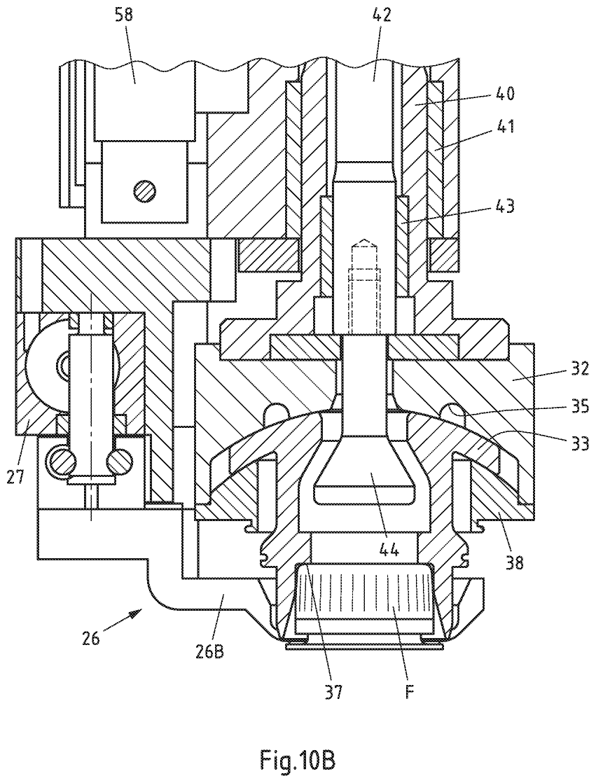

FIGS. 10A and 10B show the lower part of the gripping devices from FIG. 8A or 8B in enlarged representation, and

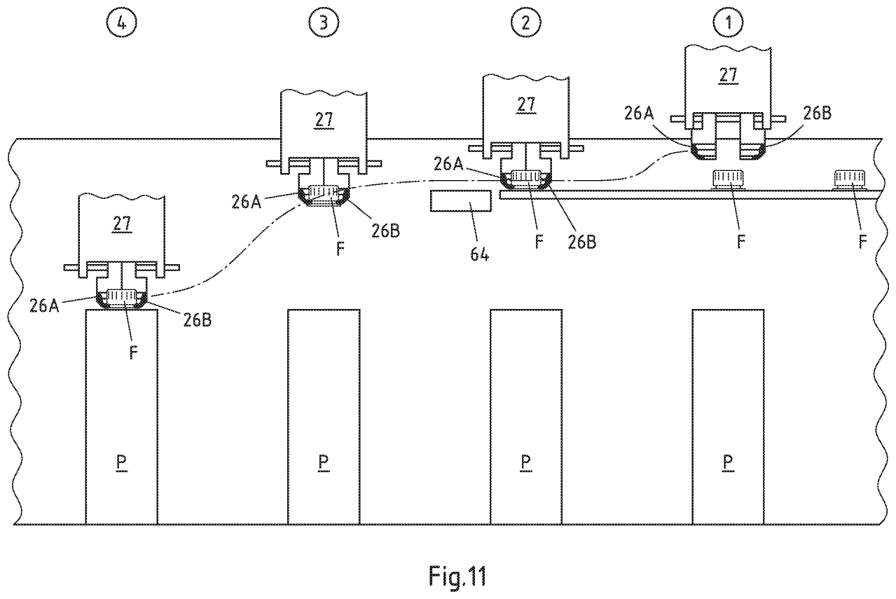

FIG. 11 shows a schematic representation of the movement path of the gripping devices in the case of the receiving and application operation of the dispensing elements.

In FIG. 1, the apparatus according to the invention is represented in plan view. It consists substantially of an applicator 1 and a supply device IF, with which packages P filled and sealed upright and supplied in the direction of the left arrow in the drawing are separated and supplied to the individual positions in transport units 2 of the applicator 1. Dispensing elements F are also delivered to the applicator 1 in order to be applied by said applicator onto the packages P. After the dispensing elements F have been applied onto the packages P, the packages P are again removed from the transport units 2 of the applicator 1 in an ejection device OF and supplied for their further use. To this end, they leave the apparatus according to the invention in the direction of the arrow on the right edge of the ejection device OF. The rotary direction runs, predefined by the arrangement of supply device IF and ejection device OF of the packages P, in the exemplary embodiment in the clockwise direction, represented by a middle arrow in FIG. 1.

FIG. 2 shows the apparatus according to the invention from FIG. 1 in the vertical section along the line II-II in FIG. 1. For improved representation, only half of the applicator 1 is represented. It can be discerned that the applicator 1 is driven by a vertical drive shaft 3 about a rotary axis 4. The drive of the applicator 1 can, however, also be carried out indirectly.

The applicator 1 designed as a rotary machine has, in the exemplary embodiment represented in FIG. 1 and preferred in this respect, twenty-four transport units 2 and correspondingly also twenty-four application units 5 which are arranged over the transport units 2. Each application unit 5 has a gripping device 6 in order to receive in each case a dispensing element F to be applied. The dispensing elements F are applied by the gripping elements 6 after corresponding application of a joining means on the gable surfaces of the packages P inclined outwards in relation to the applicator 1 and pressed on there until drying or hardening.

FIG. 2 shows the application unit 5 in its application position in which the gripping device 6 presses the received dispensing element F on the gable surface of the package P clamped in the transport unit 2. According to the invention, the gripping device 6 is arranged on the application unit 5 by means of a four bar linkage about which further detail will be given later.

In the represented exemplary embodiment, each application unit 5 has a housing 7 which is fastened at the top on a carrier disc 8 arranged in the upper region of the applicator 1, wherein the carrier disc 8 is connected in a torque-proof manner to the drive shaft 3 of the applicator 1 in the represented and in this respect preferred exemplary embodiment. The housing 7 is supported below on a rotating bezel 9 which is arranged coaxially around a support ring 10 of the applicator 1. The support ring 10 is connected to an adjustment device to adjust the transport units 2. As will be explained in more detail further below, both the rotating bezel 9 and the support ring 10 are designed in two parts and thus enclose a common bearing 11. In this way, the position of the gripping device 6 can be modified in the circumferential direction in relation to the position of the transport unit 2 located therebelow within predefined limits in order to align the dispensing element F to be applied optimally on its application location on the package gable.

In the interior of the housing 7, a gear wheel 12 can be discerned which is rotatable about a horizontally running rotary axis 13. The teeth located in the lower region of the gear wheel 12 engage into the teeth of a rack 15 fixedly arranged on a control rod 14. The free end of the control rod 14 has a rotatably arranged control roll 16 which rolls on a control curve 17. The control curve 17 is fastened on a stationary carrier disc 18 of the applicator 1. In order that the control roll 16 always rolls in fixed contact on the control curve 17, the application unit 5 is designed spring-loaded by a spring not designated in further detail which acts via the gear wheel 12 indirectly on the control rod 14.

FIG. 3 shows a vertical section in the region of the separation device of the apparatus according to the invention designed as a screw conveyor 24. It can be discerned that the cylindrical structure of the screw conveyor 24 has a screw thread forming an engagement groove 25 such that in each case one dispensing element F is transported in the engagement groove 25 and are delivered at the correct point on a cam belt 20 laterally delimited by guide rails 19, which has at a corresponding distance in each case one pair of cams 20A protruding perpendicularly outwardly to the transport direction, in which cams the dispensing element F is transported to the delivery region where it is delivered to the gripping device 6 of the applicator A. the cam belt 20 is led in the region its contact with the dispensing elements F via a slide rail 21 and is led around deflection rollers 22 and a tension roller 23. Each gripping device 6 has at its lower end in the represented and in this respect preferred exemplary embodiment two gripper jaws 26 and a drive housing 27 which are described below in greater detail.

The delivery of the dispensing elements F to the gripping devices 6 can be particularly clearly discerned from FIG. 4. Since the gripping devices 6 are arranged outside of the applicator 1 (not represented) designed as a rotary machine, they move on a circular path, while the dispensing elements F linearly approximate the delivery region, as previously mentioned for FIG. 3. In order to achieve a particularly reliable delivery here, it is discernible from FIG. 4 that the lateral guides 19 deflect, shortly before their end, the guide path towards the applicator (not represented) until the dispensing elements F have arrived exactly on the circular path of the gripping devices 6 and are then led from the guide rails 19 to their end precisely along this circular path. To this end, the slight distance between two engagement cams 20A is somewhat greater than the flange of the dispensing element F such that said dispensing element can move freely perpendicular to the transport direction of the cam belt 20 in the region of the deflected guide rail 19.

In FIG. 5, an individual gripping device 6 is now reproduced in perspective representation. In order to connect the applicator 1 via an adjustment unit (not represented), the gripping device 6 has a horizontal adjustment plate 28 and a vertical adjustment plate 29. In this way, it is possible to adjust the gripping device 6, which is connected via screws in the boreholes 30 with the adjustment device of the applicator, in its final position. To this end, the horizontal adjustment plate 28 has an adjustment screw 28A and four elongated holes aligned horizontally and not designated further in which four screws also not designated further ensure the connection to the vertical adjustment plate 29. The vertical adjustment plate also has a corresponding adjustment screw 29A and, this time vertically running elongated holes not designated in further detail in which screws not designated in further detail serve to connect to the actual gripping device 6. After fine adjustment using the adjustment screws 28A and 29A, a fixed screw connection of the adjustment plates to one another and with the actual gripping device 6 ensure its fixed connection to the adjustment unit (not represented). The interior of the gripping device 6 is in this case protected by a housing 31.

FIG. 6 shows the gripping device 6 from FIG. 5 in a side view, wherein the previously described elongated holes and the screw connections of the horizontal adjustment plate 28 and the vertical adjustment plate 29 and also the adjustment screws 28A and 29A are clearly discernible.

FIG. 7 shows a vertical section through the gripping device 6 along the line VII-VII from FIG. 5. It can be clearly discerned that the gripper jaws 26A and 26B are closed and enclose a dispensing element F. At the lower end of the gripping device 6, a support block 32 can be discerned with the pressing head 33 located therebelow. In order to achieve the pivotability of the pressing head 33 according to the invention, the support block 32 is designed below as a spherical shell 34 and the pressing head 33 on its upper side as a corresponding spherical calotte 36. It can be further discerned that the pressing head 33 has a circumferential shoulder 37 above its hollow space to receive a dispensing element F.

The base body 39 is, as already explained, screwed with the vertical adjustment plate 29. A hollow plunger 40 is firstly discernible in the interior of the vertical borehole in the base body 39 which is mounted in an upper and lower bearing shell 41 and is displaceable relative to the base body 39 in the vertical direction. An inner plunger 42 is in turn located in the interior of the hollow plunger 40, which is also mounted so as to be vertically displaceable in bearing sleeves 43 on the lower and upper end of the middle recess of the hollow plunger 40. A locking element 44 is shown at the lower end of the inner plunger 42 which expands conically downwards.

A pin 45 serves to guide the inner plunger 42 in a torque-proof manner and to delimit the axial movement of the hollow plunger 40, said pin is arranged so as to be vertically displaceable in elongated holes 46 of the hollow plunger 40. The hollow plunger 40 has, at the upper end, a ring space 47 to receive a pressure spring 48 which tensions the hollow plunger 40 with respect to an actuation arm 49 about which further detail will be given below. A shock absorber 50 can be discerned at the very top in the housing 31.

The gripper from FIG. 7 is represented in FIG. 8A in a vertical section orthogonal thereto along the line VIII-VIII in FIG. 5. Support block 32 and pressing head 33 are identical to the representation in FIG. 7 due to the represented and in this respect preferred spherical mounting of the pressing head 33. To the left, the gripper 26 is discernible with the drive housing 27 and the still closed gripper jaws, of which only the rear gripper jaw 26B is discernible. FIG. 8A also shows the precise design of pin 45 of the inner plunger 42 and the two elongated holes 46 in the hollow plunger 40. Moreover, it is discernible that the actuation arm 49 already described for FIG. 7 projects and is mounted so as to be vertically displaceable by means of a guide axis 51 in a bearing sleeve 52 at the upper end of the base body 39.

The actuation arm 49 is actuated by means of a connection head 53 which is connected by means of a bolt 54 to the actuation arm 49. The connection head 53 has an actuation arm 55 at the lower end, which is connected to a piston 56 represented only with a dashed line which is arranged in a cylinder 57. The indicated piston-cylinder unit 56, 57 is located in a drive housing 58. It can be discerned that the piston 56 is located in an upper position such that the actuation arm 49 has moved the locking element to its upper position by means of the inner plunger 42. In this locked position, the pressing head 33, through the conical configuration of the locking element 44, on the one hand, and the correspondingly conical configuration of the opening tapering upwards in the pressing head 33, is pulled centred towards the support block 32 such that the pressing head 33 is located in a horizontally aligned position. A position is thus described in which the gripping device 6 has previously received the dispensing element F, which is supplied to the gripping device 6 in a horizontally aligned manner. The gripper jaws 26A and 26B are still closed in this locked positon.

FIG. 8B now shows the same representation as in FIG. 8A, but wherein the locking element 44 is represented unlocked by the piston 56 being located in a lower position and the locking element being located over the actuation arm 49 and the inner plunger 42 counter to the effect of the spring force by the pressure spring 48 in the unlocked position. This position corresponds to the situation after placing the dispensing element F on the gable surface of the package, wherein through the unlocking of the pressing head 33 it can displace from its horizontal position into the position adapted to the actual package situation.

In order to reduce the friction between support block 32 and pressing head 33, an air current is introduced with a pressure through the ring channel 35 which is sufficient for a small air cushion to form between ring calotte guide and assigned spherical shell surface. The gripper 26 is open in FIG. 8B such that the circumferential shoulder 37 of the pressing head 33 presses on the screw cap of the dispensing element F and thus exerts a pressing force uniformly distributed around the entire circumference of the dispensing element F in order to uniformly distribute the adhesive and to thereby achieve optimal adhesion of the dispensing element F on the package surface.

The core piece of a gripper 26 of each gripping device 6 is represented in more detail in FIGS. 9A and 9B. The gripper jaws 26A and 26B are shown there in their closed and open position. The gripper jaws 26A and 26B can be moved linearly towards one another in the exemplary embodiment represented and in this respect preferred. To this end, each gripping device firstly has a housing 27 in which the mounting of the gripper jaws 26A and 26B is housed. To this end, the housing 27 has at its ends two shoulders 27A and 27B reaching downwards and, on the housing-side end of the gripper jaws 26A, a bearing block 61B is provided and, on the gripper jaw 26B, a corresponding bearing block 61B is provided. The bearing block 61A is in this case fixedly connected to a guide axis 62 and the bearing block 61B to a guide axis 63. Since the guide axis 62 also extends through the bearing block 61B and the guide axis 63 through the bearing block 61A, these bearing blocks 61A and 61B are also provided with corresponding bearings (not represented) to guide the other guide axis in each case.

In order to better illustrate the mode of action of the locking or unlocking of the pressing head 33, the lower regions of the gripping device 6 are represented enlarged in FIGS. 10A and 10B similar to the representation of FIGS. 8A and 8B.

In contrast, in the open gripper position in FIG. 10B, the pressing head 33 presses with its shoulder 37 against the screw cap of the dispensing element F, whereby the dispensing element F is fixedly pressed on the package located therebelow (not represented) until a fixed connection is achieved, after which the gripping device 6 is raised again and the package P provided with the dispensing element F can leave the applicator 1.

Lastly, FIG. 11 shows in schematic representation the movement of the gripping device 6 in the case of the application operation. In its uppermost position, position \textcircled{1} in which the gripper jaws 26A and 26B are open, it is lowered to receive a dispensing element F provided below the gripping device and initially encompasses the screw cap of the dispensing element F in order to ensure its transport after the forced guidance carried out in the delivery region. In this case, the gripper jaws 26A and 26B close and the dispensing element F is gripped in the groove between screw cap and flange in a positive-locking and force-fitting manner, as represented in position \textcircled{2}. Thereafter, it initially remains at the height of the delivery region and, in the case of further transport, wets the underside of the fastening flange of the dispensing element F with an adhesive in an application station 64, which is only indicated. Such application stations are known separately for example from DE 100 17 609 A1 going back to the applicant.

Thereafter, the vertical pivoting of the gripping device 6 begins in the direction of the package P located below the gripping device 6. Here, a somewhat deeper position \textcircled{3} is firstly shown in an intermediate position. The gripping device 6 is now pivoted further downwards into its lowermost position in which the dispensing element F is applied on the gable surface of the package P, represented as position \textcircled{4}. The gripper jaws 26A, 26B open here in a subsequent step (not represented) and the flange in the dispensing element F is pressed by the pressing head at the optimal angle adapted to the respective situation on the gable surface of the package P.

The gripping device 6 remains in this application position in the applicator 1 and presses the dispensing element F against the gable of the package until the adhesive has dried. Then, it releases the dispensing element F and moves back into its uppermost position, position \textcircled{1} in order to receive a further dispensing element F following a rotation of the applicator 1. This operation is repeated in the case of constant rotational movement of the applicator 1 for each attached gripping device 6 during the application operation.

For a better overview, an oblique position of gripping device 6 and dispensing element F and the package gable of the packages P have been dispensed with in the schematic representation in FIG. 6. Furthermore, the gripper jaws 26A and 26B are represented pivoted about a vertical axis 90° for simplicity in order to be able to show the initially open and subsequently closed position of the gripper jaws 26A and 26B.

1. A method of applying dispensing elements, fixed by means of a gripping device of an applicator and having a flange and a screw cap, onto packages, in particular cardboard/plastic composite packages for dispensable products, wherein each dispensing element is supplied to the gripping device in an aligned position, gripped by gripper jaws of a gripper of the gripping device and is applied by said gripping device by means of its flange onto a package and pressed on there, characterised by the following steps:
gripping a dispensing element by closing the gripper jaws,
lowering each gripping device with gripped dispensing element onto a package transported therebelow into an application position,
pressing the flange of the dispensing element onto the package by means of a pressing head for a predetermined time in the application position, wherein the pressing head is freely movable in the spatial environment by a predefined angle range and can be adapted to the respective form of the package gable in the case of pressing and in that the middle point of the intended adhesive surface remains immovable and
raising each gripping device to receive a newly-supplied dispensing element.

2. The method according to claim 1,
characterised in that
the pressing head of the gripping device is unlocked prior to pressing on the flange of the dispensing element.

3. The method according to claim 2,
characterised in that
the pressing head of the gripping device after it is unlocked is freely movable in the spatial environment by a predefined angle range by way of a spherical mounting.

4. The method according to claim 3,
characterised in that
the friction of the contact surfaces of the spherical mounting is minimised by an air cushion.

5. The method according to claim 2,
characterised in that
the gripping device defines a vertical axis and in that the pressing head of the gripping device is aligned to lock exactly parallel to the vertical axis of the gripping device.

6. The method according to claim 1,
characterised in that
the flange of each dispensing element is wetted with an adhesive after gripping by an application station to wet the flange of the dispensing element.

7. The method according to claim 1,
characterised in that
the flange of each dispensing element is activated by means of heat, UV light or the like after gripping by an activation station to activate the contact region of the flange of the dispensing element.

8. An apparatus for applying dispensing elements, fixed by means of a gripping device of an applicator and having a flange and a screw cap, onto packages, in particular cardboard/plastic composite packages for dispensable products, wherein each dispensing element is supplied to the gripping device in an aligned position, gripped by gripper jaws of a gripper of the gripping device and is applied by said gripping device by means of its flange onto a package and pressed on there,
wherein
each gripping device has at least one axial displaceable pressing head above the gripper jaws which is movably arranged on a support block of the gripping device, in that the pressing head is lockable by means of a locking apparatus in an aligned position and, in the case of a released locking apparatus, its contact surface for pressing on the dispensing element can adapt to the individual alignment of the dispensing element according to its respective position on the gable surface of the package in order to transfer the actual pressing force uniformly on the dispensing element to ensure a uniform connection to the package surface,
characterised in that
the pressing head is designed on its upper side as a spherical calotte and in that the support block has a corresponding spherical shell.

9. The apparatus according to claim 8,
characterised in that
the applicator is designed as a rotary machine.

10. (canceled)

11. The apparatus according to claim 8,
characterised in that
a ring channel uniformly introduce air to reduce the friction between spherical calotte and spherical shell is provided in the spherical shell.

12. The apparatus according to claim 8,
characterised in that
the pressing head has in the upper region of the spherical calotte a circumferential shoulder which is movably mounted in a ring gap between spherical shell and a support ring arranged under the support block and in that the support ring to this end also has the shape of a spherical calotte on its upper side.

13. The apparatus according to claim 8,
characterised in that
the pressing head is designed so as to be fixable by means of a locking device in a centred position.

14. The apparatus according to claim 13,
characterised in that
the locking device has a locking element protruding into a hollow space of the pressing head which conically expands downwards and in that the hollow space in the pressing head tapers correspondingly conically upwards.

15. The apparatus according to claim 13,
characterised in that
the locking element is displaceable into an unlocked position from its locked position by means of a plunger in order to ensure the free pivotability of the pressing head.

16. The apparatus according to claim 15,
characterised in that
an inner plunger axially displaceable in a base body of the gripping device for locking or unlocking the pressing head is preferably provided as the plunger.

17. The apparatus according to claim 16,
characterised in that
the inner plunger is displaceably mounted in a hollow plunger and in that the hollow plunger is fixedly connected to the support block.

18. The apparatus according to claim 17,
characterised in that
the hollow plunger is also mounted so as to be axially displaceable in the base body.

19. The apparatus according to claim 15,
characterised in that
an actuation arm is provided to actuate the plungers which is fixedly connected to the inner plunger.

20. The apparatus according to claim 19,
characterised in that
the hollow plunger is pretensioned in a spring-loaded manner against the actuation arm.
